(19) United States
(12) Patent Application Publication
(10) Pub. No.: US 2002/0089649 A1
(43) Pub. Date: Jul. 11, 2002

(54) Optical engine assembling

(76) Inventor: Guan-Jey Leu, Taipei Hsien (TW)

Correspondence Address: J.C. Patents, Inc., 4 Venture, Suite 250, Irvine, CA, 92618, US

(21) Appl. No.: 09/814,645

(22) Filed: Mar. 22, 2001

(30) Foreign Application Priority Data
Jan. 8, 2001 (TW) 90100337

(51) Int. Cl. G03B 21/00

(52) U.S. Cl. 353/31

(57) ABSTRACT

A method is used to design an optical engine for increasing performance. The method is directed to positioning dichroic mirrors at proper locations, such as, on the light paths of red, green, and blue lights, or on the locations where the optical noises are to be filtered. In such manner, the dichroic mirrors can reflect the optical noises of the red, green, and blue lights generated by the optical engine into the space other than the optical engine. As a result, the red, green, and blue lights passing through the dichroic mirrors can each be a pure light.

### CROSS-REFERENCE TO RELATED APPLICATION

This application claims the priority benefit of Taiwan application serial no. 90100337, filed Jan. 8, 2001.

### BACKGROUND OF THE INVENTION

1. Field of Invention

The present invention relates to an optical engine design. More particularly, the present invention relates to a method for improving performance of an optical engine design, where a dichroic mirror is properly positioned in an optical engine, so as to reduce optical noises in the system, and reduce the thermal effect from the optical beam. The contrast and the saturation of color coordinate of the optical engine can be effectively improved.

2. Description of Related Art

Recently, liquid crystal display (LCD) device has been widely applied in the daily life, such as liquid crystal TV, portable computer, or liquid crystal projector. Usually, a projecting system of a liquid crystal projector includes an optical engine system that is categorized into two types. One is an off axial type, and the other is an on-line type. The off axial type has a property that the incident light source and the outputting light source are not located on the same plane, while the on line type has a property that the incident light source and the outputting light source are located on the same plane. The current projecting manner of the liquid crystal projector can further be categorized into a front projecting manner and a back projecting manner. The current design of the liquid crystal projector more often takes the back projecting manner and on line type. In the technology field of liquid crystal projector, the projecting quality and the weight and dimension of the optical engine are the main concerned issues.

FIG. 1 is system block diagram, schematically illustrating a conventional optical engine system of a liquid crystal projector with reflection type. In FIG. 1, the optical engine system 100 uses light source 102 that emits a white light W. The white light travels through a filter, such that the ultra-violet component and the infra-red component are filtered away. The light continuously transmits through an S-P converter, where S represents S-polarization and P represents P-polarization. As a result, a white light WS with S-polarization is obtained and is incident onto a reflection mirror 104. After reflection, the white light WS is incident onto a dichroic mirror 106 that divides the incident white light WS into a BSGS mixed light and a RS red light.

The BSGS mixed light is the component mixed by blue and green components and is reflected by the dichroic mirror 106, while red light RS is the component transmitting through the dichroic mirror 106. The red light RS continuously travels onto a reflection mirror 108 and then is reflected onto a polarization splitter 110. The polarization splitter 110 reflects the S-polarization component of the red light RS onto a red liquid crystal panel 112. The BSGS mixed light reflected by the dichroic mirror 106 travels through a dichroic mirror 114, whereby the green component and the blue component are respectively split into a green light GS through reflection and a blue light BS through transmission. The green light GS travels onto a polarization splitter 116 that reflects the S-polarization component of the green light GS onto a green liquid crystal panel 118. The transmitting blue light BS travels on to a polarization splitter 120 that reflects the S-polarization component of the blue light BS onto a blue liquid crystal panel 122. Then, the red liquid crystal panel 112, the green liquid crystal panel 118, and the blue liquid crystal panel 122 respectively reflect the incident red light RS, the green light GS, and the blue light BS, and change the S-polarization into P-polarization, whereby a red light RP, a green light GP, and a blue light BP travel onto an X-cube dichroic prism 124 for recombination. After recombination, the lights travels to a projector lens 126 and then are projected onto a screen (not shown).

FIG. 2 is system block diagram, schematically illustrating a conventional optical engine system of a liquid crystal projector with transmitting type. In FIG. 2, an optical engine system 200 has a light source 202 that emits a white light W. The white light W is converted by an S-P converter 203 into an S-polarization white light WS. The white light WS is reflected by a reflection mirror 204 onto a dichroic mirror 206. The dichroic mirror 206 splits the white light WS into a mixed light through reflection and a red light through transmission. The mixed light includes a mix of blue and green components. The red light RS is reflected by a reflection mirror 208 onto a red liquid crystal panel 210 and reaches to an X-cube dichroic prism 212. The blue component and the green component of the mixed light is split by a dichroic mirror 214 into a blue light BS through transmission and a green light GS through reflection. The green light GS is reflected onto a green liquid crystal panel 211, and then reaches to the X-cube dichroic prism 212. The transmitted blue light BS is then further reflected by a dichroic mirror 218, and then the component of S-polarization travels onto a reflection mirror 220. The reflection mirror 220 reflects the blue light onto a blue liquid crystal panel 222. The blue light then enters the X-cube dichroic prism 212. The red light RS, the green light GS, and the blue light BS are recombined by the X-cube dichroic prism 212, and are projected onto a screen (not shown) by a projection lens 224.

FIG. 3 is a system block diagram, schematically illustrating another conventional optical engine system of a liquid crystal projector with reflection type. In FIG. 3, an optical engine system 300 has a light source 302 that emits white light W. The white light W is converted into a white light WS with S-polarization through an S-P converter. Three components R, G, B of the white light WS are properly reflected onto red, green, blue liquid crystal panels 308, 310, 312, respectively, through a polarization splitter 304 and a dichroic mirror 306. The red, green, blue liquid crystal panels 308, 310, 312 then reflect back the lights through the same light path. As a result, the red light, the green light, and the blue light are recombined and projected onto a screen through a projection lens.

In the above conventional liquid crystal projectors, no matter whether the reflection type or the transmission type is used, three components of red, green, and blue of the lights travelling through the dichroic mirror or polarization splitter are not purely monochromatic. This results in optical noise. The optical noise cannot be controlled and reduced by liquid crystal panel, and aggravates the thermal effect for each optical path. As a result, when the liquid crystal panel is at a dark state, the optical noise causes a stronger contrast of the optical noise. When it is at a bright state, the phenomenon of color impurity may occur, and even results in an issue of thermal effect that affects the transmission rate, and then affects the projection quality of the optical engine system.

### SUMMARY OF THE INVENTION

One object of the invention is to introduce a method for effective improving performance of a system of the liquid crystal projector by properly positioning the dichroic mirror in the optical engine system, so that the optical noise would be reflected away from the optical engine system.

As embodied and broadly described herein, the invention provides a method for assembling an optical engine with improved performance. The method includes positioning dichroic mirrors at proper locations, such as, on the light paths of red, green, and blue lights, or on the locations where the optical noises are to be filtered. In such manner, the dichroic mirrors can reflect the optical noises of the red, green, and blue lights generated by the optical engine into the space other than the optical engine. As a result, the red, green, and blue lights passing through the dichroic mirrors can each be a pure light. This can improve the light contrast in the optical engine and the saturation level of color coordinate. The performance can be effectively improved.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is system block diagram, schematically illustrating a conventional optical engine system of a liquid crystal projector with reflection type;

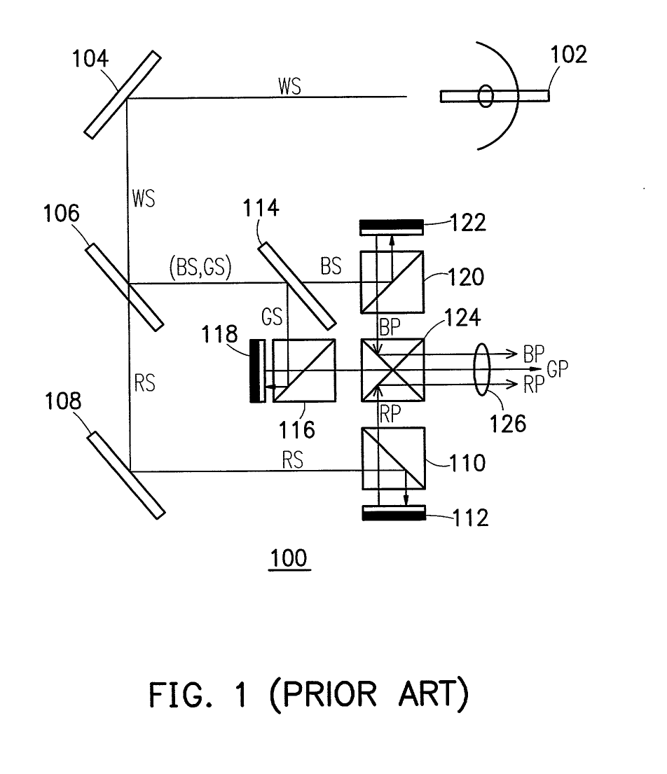

FIG. 2 is system block diagram, schematically illustrating a conventional optical engine system of a liquid crystal projector with transmitting type;

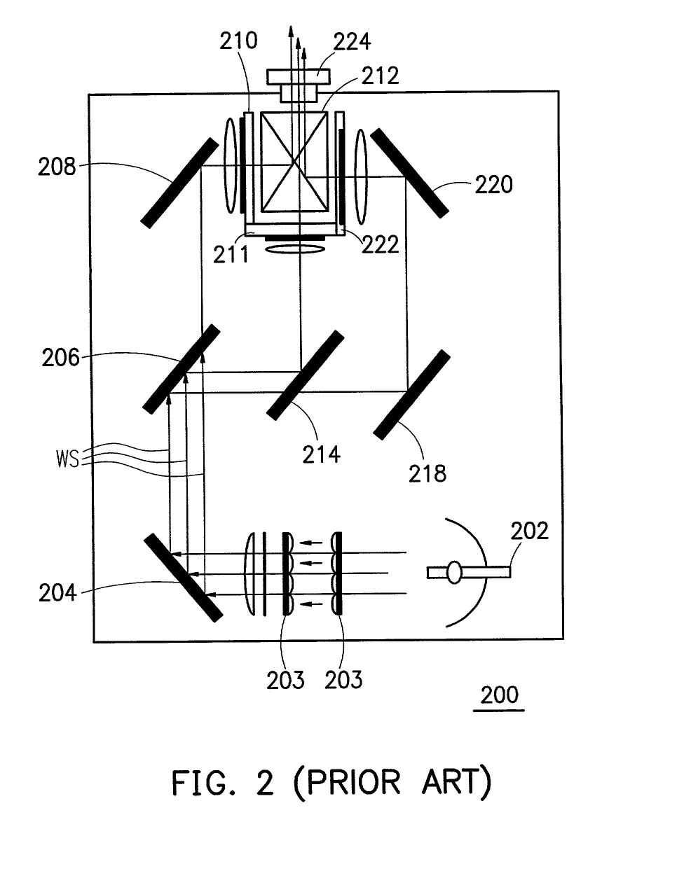

FIG. 3 is a system block diagram, schematically illustrating another conventional optical engine system of a liquid crystal projector with reflection type;

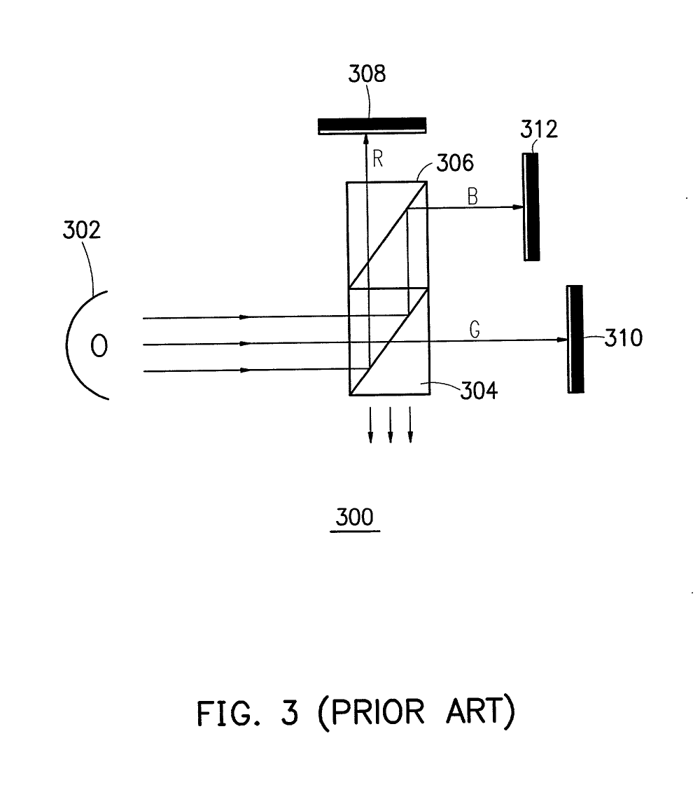

FIG. 4 is a system block diagram, schematically illustrating an optical engine system of a liquid crystal projector with reflection type, according to one preferred embodiment of this invention;

FIG. 5 is a system block diagram, schematically illustrating an optical engine system of a liquid crystal projector with transmission type, according to one preferred embodiment of this invention; and

FIG. 6 is a system block diagram, schematically illustrating another optical engine system of a liquid crystal projector with reflection type, according to one preferred embodiment of this invention.

### DESCRIPTION OF THE PREFERRED EMBODIMENTS

In the invention, the dichroic mirrors are positioned at the proper locations in the optical engine, such as on the light path of each the red, green, and blue lights, just in front of liquid crystal panel. This arrangement can reduce the optical noise of the optical engine, the thermal effect due to the light beam, and improve the light contrast in the optical engine and the saturation level of color coordinate.

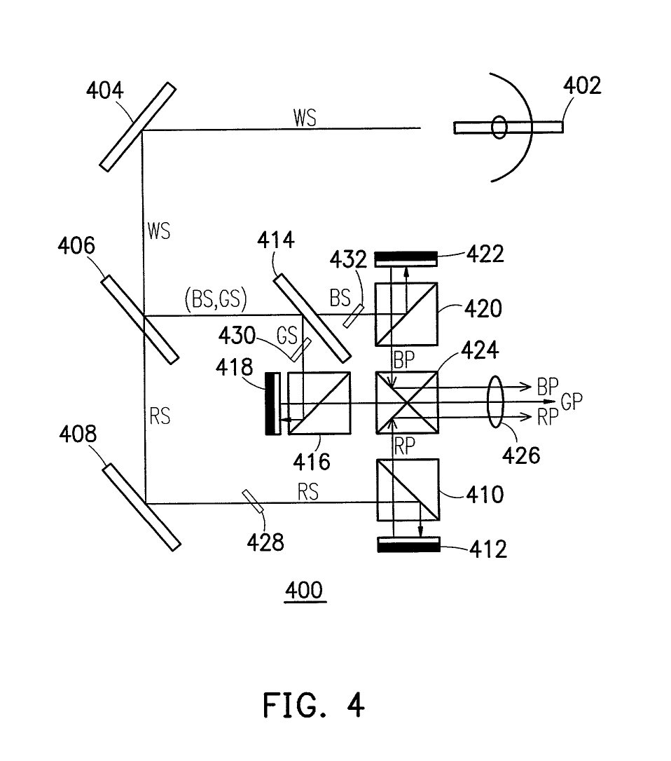

FIG. 4 is a system block diagram, schematically illustrating an optical engine system of a liquid crystal projector with reflection type, according to one preferred embodiment of this invention. In FIG. 4, the optical engine 400 includes a light source 402 that can emit white light W. The white light W travels through an S-P converter, whereby a white light with S-polarization WS is generated. The white light WS is incident onto a reflection mirror 404, which then reflects the white light WS onto a dichroic mirror 406. The dichroic mirror 406 splits the white light WS into a mixed light BSGS of blue component and green component through reflection, and a red light RS through direct transmission. The transmitted red light RS is then incident onto a reflection mirror 408 and then is reflected onto a dichroic mirror 428, and continuously travels to a polarization splitter 410. The polarization splitter 410 then reflects the S-polarization component of the red light RS onto a red liquid crystal panel 412. Returning to the dichroic mirror 406, the mixed light BSGS travels onto a dichroic mirror 414, which split the mixed light BSGS into a green light GS through reflection and a blue light BS through transmission. The reflected green light GS travels through a dichroic mirror 430 and enters a polarization splitter 416. The polarization splitter 416 then reflects the S-polarization component of the green light GS onto a green liquid crystal panel 418. The blue light BS travels through a dichroic mirror 432 and enters onto a polarization splitter 420. The polarization splitter 420 then reflects the S-polarization component of the blue light BS onto a blue liquid crystal panel 422.

The red liquid crystal panel 412, the green liquid crystal panel 418, and the blue liquid crystal panel 422 respectively reflect the incident red light RS, the green light GS, and the blue light BS, and change the S-polarization into P-polarization, whereby a red light RP, a green light GP, and a blue light BP travel onto an X-cube dichroic prism 424 for recombination. After recombination, the lights travels to a projector lens 426 and then are projected onto a screen (not shown).

In the foregoing, the dichroic mirrors 428, 430, 432 can reflect optical noises of the red, green, and blue lights away from the optical engine 400. In principle, the angle of the dichroic mirrors 428, 430, 432 can be set to any designed angle and any location on the light path, which can reflects the optical noises away from the optical engine 400.

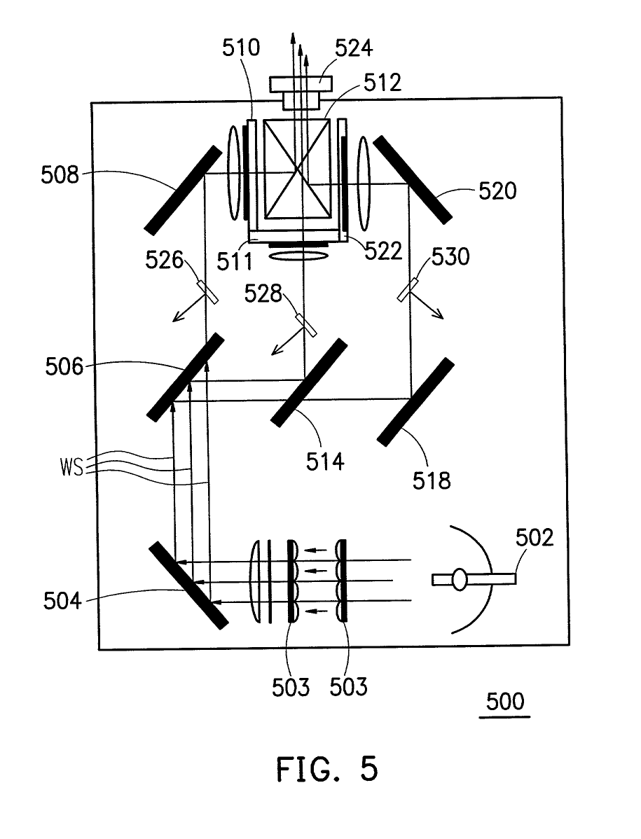

FIG. 5 is a system block diagram, schematically illustrating an optical engine system of a liquid crystal projector with transmission type, according to one preferred embodiment of this invention. In FIG. 5, an optical engine system 500 has a light source 502 that emits a white light W. The white light W is converted by an S-P converter 503 into an S-polarization white light WS. The white light WS is reflected by a reflection mirror 504 onto a dichroic mirror 506. The dichroic mirror 506 splits the white light WS into a mixed light through reflection and a red light through transmission. The mixed light includes a mix of blue and green components. The red light RS travels through a dichroic mirror 526 and reaches to a reflection mirror 508. The reflection mirror 508 reflects the red light onto a red liquid crystal panel 510 and the red light reaches to an X-cube dichroic prism 512. The blue component and the green component of the mixed light is split by a dichroic mirror 514 into a blue light BS through transmission and a green light GS through reflection. The green light GS is reflected onto a dichroic mirror 528 and enters a green liquid crystal panel 51 1, and then reaches to the X-cube dichroic prism 512. The transmitted blue light BS is then further reflected by a dichroic mirror 518, and then the component of S-polarization travels through a dichroic mirror 530 and in incident onto a reflection mirror 520. The reflection mirror 520 reflects the blue light onto a blue liquid crystal panel 522. The blue light then enters the X-cube dichroic prism 512. The red light RS, the green light GS, and the blue light BS are recombined by the X-cube dichroic prism 512, and are projected onto a screen (not shown) by a projection lens 524.

In the foregoing, the dichroic mirrors 526, 528, 530 can reflect optical noises of the red, green, and blue lights away from the optical engine 500. In principle, the angle of the dichroic mirrors 526, 528, 530 can be set to any designed angle and any location on the light path, which can reflects the optical noises away from the optical engine 500.

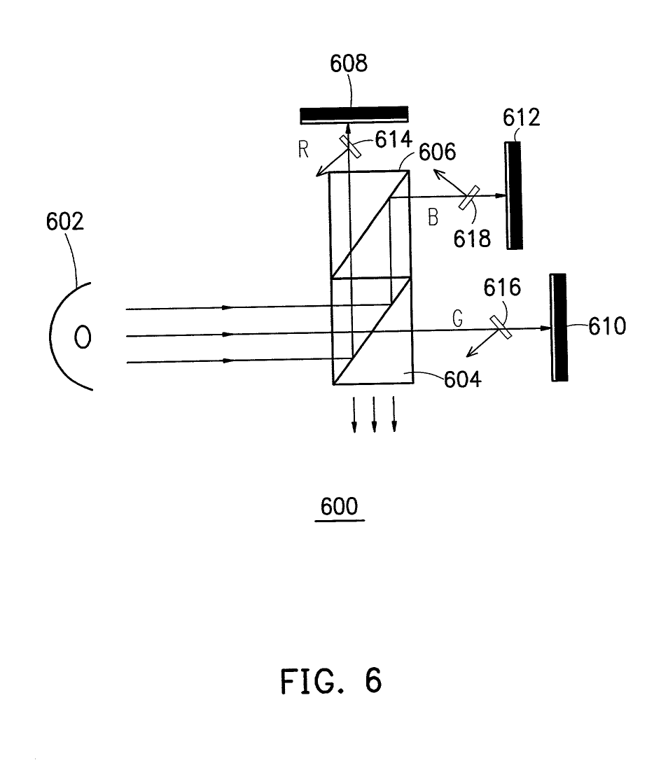

FIG. 6 is a system block diagram, schematically illustrating another optical engine system of a liquid crystal projector with reflection type, according to one preferred embodiment of this invention. In FIG. 6, an optical engine system 600 has a light source 602 that emits a white light W. The white light W is converted into a white light WS with S-polarization through an S-P converter (not shown). Three components R, G, B of the white light WS are properly reflected onto red, green, and blue liquid crystal panels 608, 610, 612, respectively, through a polarization splitter 604 and a dichroic mirror 606. Before the red, green, and blue lights enter the liquid crystal panels 608, 610, 612, each the lights also additionally travel through the dichroic mirrors 614, 616, 618, respectively. The red, green, blue liquid crystal panels 608, 610, 612 then reflect back the lights through the same light path. As a result, the red light, the green light, and the blue light are recombined and projected onto a screen through a projection lens.

In the foregoing, the dichroic mirrors 614, 616, 618 can reflect optical noises of the red, green, and blue lights away from the optical engine 600. In principle, the angle of the dichroic mirrors 614, 616, 618 can be set to any designed angle and any location on the light path, which can reflects the optical noises away from the optical engine 600.

In conclusion, the invention has at least the advantages as follows:

1. The invention includes a few of dichroic mirrors, which are positioned at the proper locations in the optical engine, such as just in front of liquid crystal panel. This arrangement can reduce the optical noise of the optical engine, the thermal effect due to the light beam. The projection quality is effectively improved.

2. The invention includes a few of dichroic mirrors, which are positioned at the proper locations in the optical engine, such as on the light path of each the red, green, and blue lights. This arrangement can improve the light contrast in the optical engine and the saturation level of color coordinate. The projection quality is effectively improved.

3. The invention uses dichroic mirrors to achieve the filtering effect on the optical noises. The whole design principle of the optical engine is not necessary to be greatly modified, and the projection quality can be greatly improved. The fabricating cost still remains without raising.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A method for assembling optical engine, suitable for use in a liquid crystal projector, the method at least comprising:
providing an optical engine system, wherein the optical engine system at least comprises a light source, an optical splitting system, an optical recombination system, a plurality of liquid crystal panels, and an projecting lens, wherein the optical splitting system splits a light from the light source into a first color light, a second color light, and a third color light; and
positioning a plurality of dichroic mirrors on light paths of the first color light, the second color light, and the third color light, so as to reflect optical noises away from the optical engine system.

2. The method of claim 1, wherein a light path set in the optical engine system comprises a reflection type for the liquid crystal projector.

3. The method of claim 1, wherein a light path set in the optical engine system comprises a transmission type for the liquid crystal projector.

4. A method for fabricating an optical engine, the method comprising:
providing a optical ending system which has a first color light path, a second color light path, and a third color light path; and
positioning a plurality of dichroic mirrors on the first color light path, the second color light path, and the third color light path, so as to reflect optical noises away from the optical engine system.

5. The method of claim 4, wherein the light paths set in the optical engine system comprises a reflection type for a liquid crystal projector.

6. The method of claim 1, wherein the light paths set in the optical engine system comprises a transmission type for a liquid crystal projector.
